(19) United States
(12) Patent Application Publication
(10) Pub. No.: US 2014/0329544 A1
(43) Pub. Date: Nov. 6, 2014

(54) SYSTEM AND METHOD FOR MANAGING INFORMATION OF PARKING LOT, AND PARKING LOT INFORMATION PROVIDING APPARATUS

(71) Applicant: Hyundai Motor Company, Seoul (KR)

(72) Inventors: Sung Yun Kim, Seoul (KR); Suk Young Rho, Anyang-si (KR); Jung Hoon Oh, Yongin-si (KR); Hyo Geun Kwak, Daegu (KR); Min Wook Seo, Suwon-si (KR)

(73) Assignee: Hyundai Motor Company, Seoul (KR)

(21) Appl. No.: 13/974,755

(22) Filed: Aug. 23, 2013

(30) Foreign Application Priority Data
May 6, 2013 (KR) 10-2013-0050508

(51) Int. Cl. H04W 4/04

(52) U.S. Cl. CPC H04W 4/046
USPC 455/456.3

(57) ABSTRACT

A system and a method for managing information of a parking lot, and parking lot information providing apparatus are provided. The includes a processor of a vehicle that recognizes information of a wireless access point (Wi-Fi AP) in the parking lot and a storage server that receives the information of the Wi-Fi AP for each parking lot from the processor to store into a database. The storage server manages the information stored in the DB and provides position information based on the information of the Wi-Fi AP of the parking lot to a corresponding vehicle when the vehicle enters the parking lot. The storage server updates the information of the Wi-Fi AP previously stored for the corresponding parking lot based on the information of the Wi-Fi AP received from the vehicle that entered the parking lot.

### CROSS-REFERENCE TO RELATED APPLICATION

This application is based on and claims priority from Korean Patent Application No. 10-2013-0050508, filed on May 6, 2013 in the Korean Intellectual Property Office, the disclosure of which is incorporated herein in its entirety by reference.

### BACKGROUND

1. Field of the Invention

The present invention relates to a system and a method for managing information regarding a parking lot, and a parking lot information providing apparatus, and to a technology that manages indoor parking lot information using Wi-Fi and dead reckoning (DR) information of a vehicle.

2. Description of the Related Art

When recognizing a position via a global positioning system (GPS) module installed within a vehicle, it is possible to recognize an outdoor position. However, since a GPS signal is not received regularly (e.g., there may be signal interceptions) indoors, in a tunnel, or the like, it is difficult to recognize a position.

Moreover, a system that manages parking lot recognizes the position of the vehicle using a Wi-Fi access point (AP) installed in the parking lot to provide a parking guide service to a corresponding vehicle. However, a database (DB) that stores the information of the Wi-Fi AP for each parking lot should be built whenever the Wi-Fi AP is installed, and, moreover, when the Wi-Fi AP that was removed is not reflected correctly in may be DB, it is difficult to accurately recognize the position. In addition, there is difficulty in building the DB for each parking lot.

### SUMMARY

The present invention provides a system and a method for managing information of a parking lot that stores indoor parking lot information in a DB using Wi-Fi and DR information of a vehicle and managing a Wi-Fi AP environment information, and continuously updating the information registered in advance based on the Wi-Fi information provided from the vehicles entering the parking lot, and a parking lot information providing apparatus.

In accordance with an aspect of the present invention, a system for managing information of parking lot may include: a vehicle that recognizes information of a Wi-Fi AP in parking lot and provides the information of the Wi-Fi AP of the parking lot; and a storage server that receives the information of the Wi-Fi AP for each parking lot from at least one vehicle to store the information into DB, and manages the information of the Wi-Fi AP for each parking lot stored in the DB. In particular, the storage server provides position information based on the information of the Wi-Fi AP of the parking lot to a corresponding vehicle when the vehicle enters the parking lot, and updates the information of the Wi-Fi AP previously stored for a corresponding parking lot based on the information of the Wi-Fi AP received from the vehicle that entered the parking lot.

In accordance with another aspect of the present invention, a method for managing information of parking lot may include: recognizing information of a Wi-Fi AP of a corresponding parking lot by at least one vehicle that has entered the parking lot; receiving the information of the Wi-Fi AP recognized from the at least one vehicle, analyzing the information of the Wi-Fi AP for each parking lot and storing the information into DB based on a position of each Wi-Fi AP, by a storage server; receiving Wi-Fi environment information of the corresponding parking lot from the vehicle based on the information of the Wi-Fi AP of the parking lot provided to the vehicle from the storage server when the vehicle enters the parking lot; and updating the DB by analyzing the Wi-Fi environment information of the corresponding parking lot received from the vehicle.

In accordance with another aspect of the present invention, an apparatus for providing parking lot information may include: a Wi-Fi environment detecting unit that recognizes a Wi-Fi AP in parking lot by operating a Wi-Fi module when a vehicle enters the parking lot; a DR processing unit that obtains information of the vehicle by operating a sensor installed within the vehicle and recognizes a relative position of a corresponding vehicle in the parking lot through the obtained information; and a signal processing unit that provides the information of the Wi-Fi AP in the parking lot and relative position information of the vehicle to a storage server. In particular, the Wi-Fi environment detecting unit may be configured to compare a Wi-Fi AP list received from the storage server with the information of the Wi-Fi AP in the parking lot to sense a Wi-Fi environment change for the parking lot when the information of the Wi-Fi AP of corresponding parking lot is previously stored in the storage server, and provides the sensed Wi-Fi environment information to the storage server.

### BRIEF DESCRIPTION OF THE DRAWINGS

The objects, features and advantages of the present invention will be more apparent from the following detailed description in conjunction with the accompanying drawings, in which:

FIG. 1 is an exemplary diagram schematically illustrating a configuration of a system for managing information of parking lot according to an exemplary embodiment of the present invention;

FIG. 2 is an exemplary block diagram illustrating a configuration of a storage server according to the exemplary embodiment of the present invention;

FIGS. 3A-3B is an exemplary diagram for describing a DB building operation of a storage server according to the exemplary embodiment of the present invention;

FIG. 4 is an exemplary block diagram illustrating a configuration of a service server according to the exemplary embodiment of the present invention;

FIG. 5 is an exemplary block diagram illustrating a configuration of a parking lot information providing apparatus according to the exemplary embodiment of the present invention;

FIG. 6 is an exemplary diagram for describing a communication conversion operation of the parking lot information providing apparatus shown in FIG. 5 according to an exemplary embodiment of the present invention;

FIG. 7 is an exemplary graph describing a position calculating operation between Wi-Fi AP and vehicle in a storage server according to the exemplary embodiment of the present invention;

FIG. 8 is an exemplary flow chart illustrating a flow of operation for a method for managing information of parking lot according to the exemplary embodiment of the present invention;

FIG. 9 is an exemplary flow chart illustrating a flow of operation for a method for managing information of parking lot according to the exemplary embodiment of the present invention; and

FIG. 10 is an exemplary flow chart illustrating a flow of operation for a method for managing information of parking lot according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Hereinafter, exemplary embodiments of the present invention will be described with reference to the accompanying drawings.

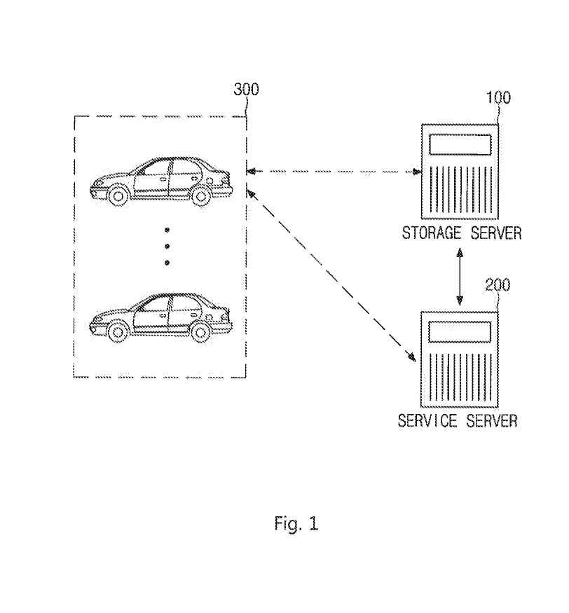

FIG. 1 is an exemplary diagram schematically illustrating a configuration of a system for managing information of parking lot according to an exemplary embodiment of the present invention.

Referring to FIG. 1, a system for managing information of parking lot may include a storage server 100, a service server 200, and a vehicle 300.

The storage server 100 may be configured to receive information regarding a Wi-Fi AP collected from vehicles 300 positioned at a parking lot and may be configured to store the information of the Wi-Fi AP for each parking lot to build and manage a DB. In particular, the storage server 100 may be configured to build the DB based on the information provided from a vehicle for building Wi-Fi AP DB for collecting the information. Further, the storage server 100 may also be configured to build the DB based on the information provided from the vehicle of general customers using the parking lot.

In this case, the storage server 100 may be configured to generate a Wi-Fi AP list for at least one of the Wi-Fi APs positioned at the parking lot and may be configured to store at least one of a group consisting of: identification information, access information, signal strength information, position information, and reliability information in response to each Wi-Fi AP in the Wi-Fi AP list. As an example, the storage server 100 may be configured to store service set identifier (SSID), media access control (MAC) address, signal strength, noise strength, coordinate information, and the like. In particular, the storage server 100 may be configured to estimate a position of the Wi-Fi AP by analyzing a signal of the Wi-Fi AP based on location coordinates in the parking lot. Meanwhile, the storage server 100 may also be configured to store at least one Wi-Fi AP information obtained at a predetermined position in the parking lot in the DB in response to the predetermined position information.

In addition, the storage server 100 may be configured to periodically analyze intensity of the AP signal received from the vehicles 300 to calculate reliability for each Wi-Fi AP. Specifically, the calculated reliability information may be stored in the DB in response to a corresponding Wi-Fi AP.

Meanwhile, the storage server 100 may be configured to receive the information of the Wi-Fi AP of the corresponding parking lot from the vehicles of general customers using the parking lot to continuously manage the information stored in the DB, and update the changed Wi-Fi AP information. In particular, the storage server 100 may be configured to update at least one of a removed AP, an added AP, and an AP having a signal strength which is a reference value or less among pre-registered Wi-Fi APs for the parking lot.

The service server 200 and the storage server 100 may be connected with a network to search the information registered in the DB. When the AP signal is received from the vehicle 300 that has entered the parking lot, the service server 200 may be configured to extract Wi-Fi AP information that corresponds to the received AP signal by searching the DB and estimate a position of the vehicle 300 based on the position information of the extracted Wi-Fi AP. In particular, the service server 200 may be configured to provide a parking guide service to the corresponding vehicle 300 based on the estimated position of the vehicle 300.

The vehicles 300 may be a vehicle of the general customers using the parking lot and a vehicle for building the Wi-Fi AP DB for collecting information. The vehicle for building the Wi-Fi AP DB for collecting information may be used to build an initial DB of the storage server 100, however, thereafter, the information of the corresponding parking lot may be provided to the storage server 100 by the vehicles of the general customers.

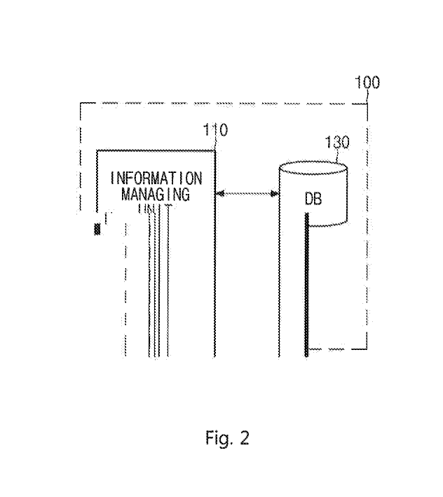

FIG. 2 is an exemplary block diagram illustrating a configuration of a storage server according to the exemplary embodiment of the present invention. Referring to FIG. 2, the storage server 100 may include an information managing unit 110, a DB 130, and a communication unit 150. The information of the Wi-Fi AP for each parking lot received from the vehicles may be stored in the DB 130. Additionally, the DB 130 may be connected with the service server by a network to permit the service server to search the information.

The communication unit 150 may be configured to receive a signal from the vehicles and transmit predetermined information related to the corresponding parking lot to the vehicles. In particular, the communication unit 150 may be configured to transmit and receive signals to and from each vehicle via a mobile communication network.

The information managing unit 110 may be configured to the information of the Wi-Fi AP for each parking lot from at least one vehicle that has entered the parking lot. In particular, the information of the Wi-Fi AP may include identification information, access information, signal strength information, and position information of the corresponding Wi-Fi AP. The information managing unit 110 may be configured to classify the information of the Wi-Fi AP received from each vehicle by each parking lot and store the information of the Wi-Fi AP for each parking lot into the DB 130.

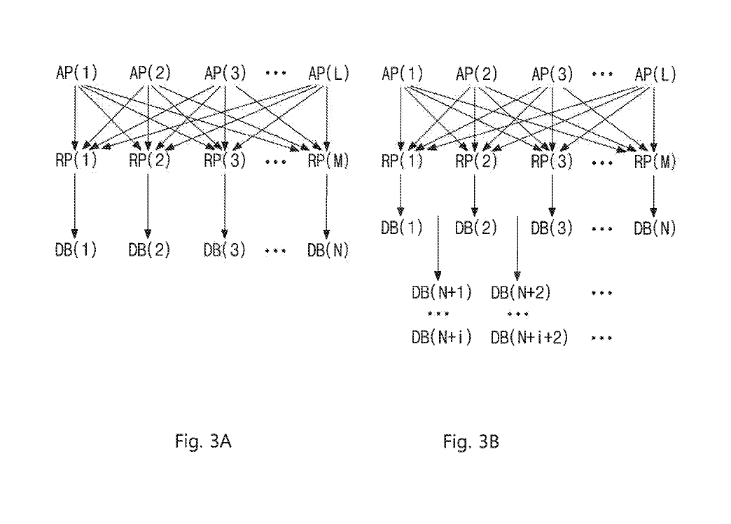

When the information of the WI Wi-Fi FI AP for each parking lot is received from the vehicle, the information managing unit 110 may be configured to estimate a position of the Wi-Fi AP by analyzing a signal of the Wi-Fi AP based on location coordinates in the parking lot to store into the DB 130. Meanwhile, the information managing unit 110 may also be configured to store at least one information of the Wi-Fi AP obtained at a predetermined position in the parking lot into the DB 130 in response to a preset position information. The operation of building the DB 130 based on the position of the Wi-Fi AP in the information managing unit 110 will be described in more detail using FIG. 3.

Furthermore, the information managing unit 110 may be configured to analyze intensity of the AP signal periodically received from the vehicle to calculate reliability for each Wi-Fi AP. In particular, the information managing unit 110 may be configured to register only the Wi-Fi AP that has a calculated reliability which is a reference value or greater in the DB 130. On the other hand, when the Wi-Fi AP has a calculated reliability less than a reference value, the Wi-Fi AP may be deleted from the DB 130.

When the vehicle enters the parking lot, the information managing unit 110 may be configured to provide the position information based on the information of the Wi-Fi AP of the parking lot stored in the DB 130 to the corresponding vehicle. In addition, the information managing unit 110 may be configured to receive the information of the Wi-Fi AP from the vehicle that has entered the parking lot, and may update the information stored in the DB 130 based on the received Wi-Fi AP information. In particular, the information managing unit 110 may be configured to update at least one of a removed AP, an added AP, and an AP having a signal strength which is a reference value or less among the Wi-Fi APs of the corresponding parking lot.

FIG. 3 is an exemplary diagram that describes a DB building operation of a storage server according to the exemplary embodiment of the present invention. First, FIG. 3(A) shows an exemplary operation of building a DB of Wi-Fi AP information based on a specific area in which the corresponding Wi-Fi AP information is received. In FIG. 3(A), AP(1) to AP(L) represent the Wi-Fi APs installed in the parking lot, and RP(1) to RP(M) represent each area in the parking lot. The storage server may be configured to build the DB(1) to DB(N) in response to the AP(1) to AP(L), respectively.

In other words, when the signals of the AP(1) to AP(L) in the RP(1) are sensed, the signal information, for example, a signal strength, a noise strength, and the like of the AP(1) to AP(L) may be stored in the DB(1) that corresponds to the RP(1). Similarly, when the signals of the AP(1) to AP(L) in the RP(2) to RP(M) may also be sensed respectively, the signal information, for example, a signal strength, a noise strength, and the like of the AP(1) to AP(L) may be stored in the DB(2) to DB(N) that correspond to the RP(2) to RP(M). In particular, all the signal information of the AP(1) to AP(L) may be stored in the DB(2) to DB(N), however, since positions of the RP(1) to RP(M) may be different from each other, the strength of the signals received from the AP(1) to AP(L) may different from each other. In some cases, the signal of a specific AP may not be sensed in a specific area.

FIG. 3(B) shows an exemplary operation of building the DB of Wi-Fi AP information based on a location information, for example, a location coordinate of the parking lot in which a corresponding Wi-Fi AP information may be received. In particular, the storage server may be configured to build the DB based on an absolute coordinate on location of the parking lot and build the DB according to relative coordinate based on a specific area. As an example, the storage server may be configured to build the DB(1) to DB(N) based on the location coordinate of the RP(1) to RP(M) and further build the DB(N+1) to DB(N+i+1) according to the relative coordinate based on the location coordinate of the RP(1) to RP(M).

Certainly, the DB building method for the Wi-Fi AP information in the parking lot as described above is just an example, but is not limited thereto and all generally used methods may be applied.

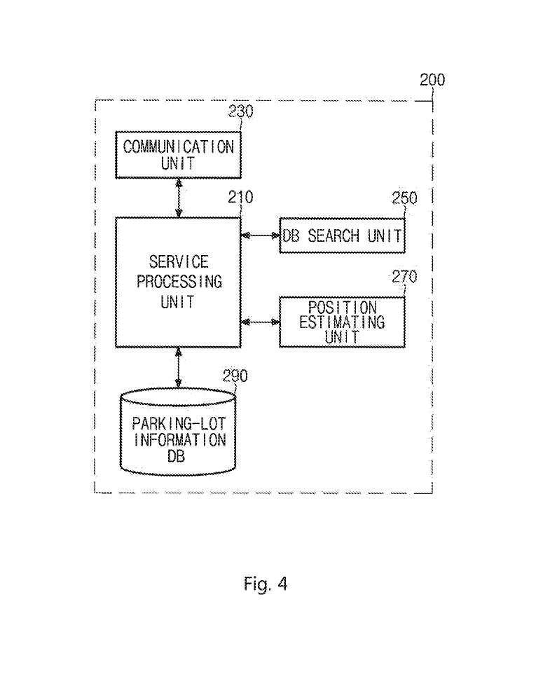

FIG. 4 is an exemplary block diagram illustrating a configuration of a service server according to the exemplary embodiment of the present invention. Referring to FIG. 4, the service server 200 may include a service processing unit 210, a communication unit 230, a DB search unit 250, a position estimating unit 270, and a parking lot information DB 290.

The communication unit 230 may include a communication interface that supports a transmission and reception of a signal with a vehicle that has entered the parking lot, and may include a communication interface that supports a connection with a storage server. In particular, the communication unit 230 may be configured to transmit and receive signals with the vehicle that has entered in the parking lot via a mobile communication network. In addition, the communication unit 230 may be connected to the storage server in a wired manner.

The service processing unit 210 may be configured to provide a parking guide service to the corresponding vehicle based on the received AP signal when the vehicle enters the parking lot. In particular, the DB search unit 250 may be configured to analyze the received AP signal when the vehicle enters the parking lot and search the Wi-Fi AP that corresponds to the received AP signal by calling the DB of the storage server. In addition, the position estimating unit 270 may be configured to extract the position information of the searched Wi-Fi AP by the DB search unit 250, and estimate the position of the corresponding vehicle based on the position information of the extracted Wi-Fi AP. Therefore, the service processing unit 210 may be configured to extract the information stored in the parking lot information DB 290 based on the position of the vehicle estimated by the position estimating unit 270 to provide to the corresponding vehicle, thereby guiding the driver of the vehicle to park.

Vehicle information parked in the parking lot, empty compartment information, parking lot map information and the like may be stored in the parking lot information DB 290. FIG. 4 shows that the parking lot information DB 290 may be included in the service server 200, however, the parking lot information DB 290 may be included in the DB of the storage server according to the exemplary embodiments of the present invention.

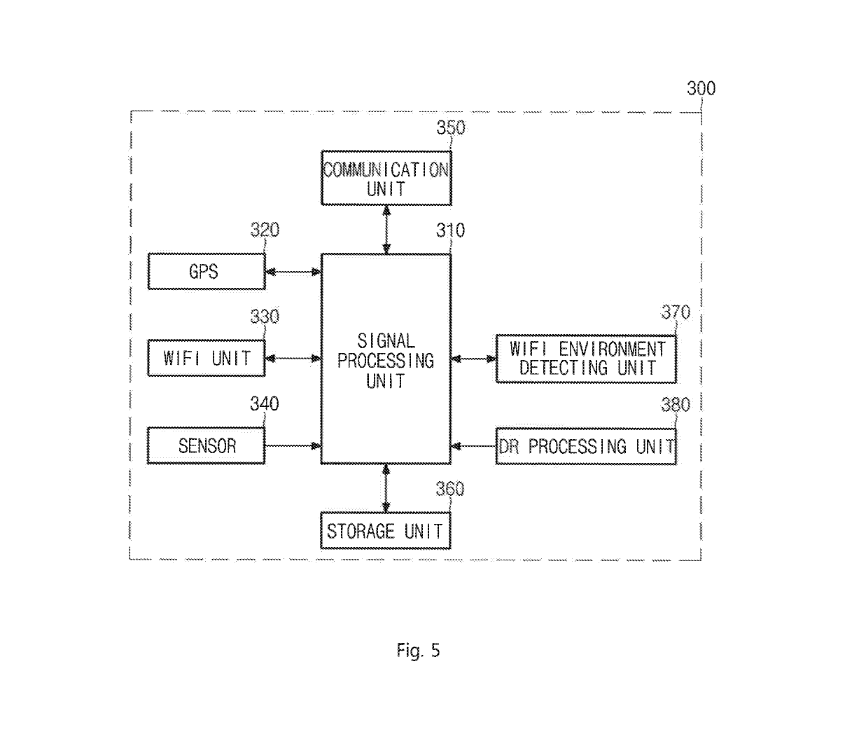

FIG. 5 is an exemplary block diagram illustrating a configuration of a parking lot information providing apparatus according to the exemplary embodiment of the present invention. In particular, a parking lot information providing apparatus of the present invention may be a vehicle or a separate apparatus installed within the vehicle. In the below exemplary embodiment, the parking lot information providing apparatus will be described as a vehicle.

Referring to FIG. 5, the vehicle 300 may include a signal processing unit 310 (e.g., a processor), a GPS 320, a Wi-Fi unit 330, a sensor 340, a communication unit 350, a storage unit 360 (e.g., a memory), a Wi-Fi environment detecting unit 370, and a DR processing unit 380. Specifically, the signal processing unit 310 may be configured to process a signal according to an operation of each part of the vehicle 300 and may be configured to operate the GPS 320, Wi-Fi unit 330, sensor 340, communication unit 350, storage unit 360, Wi-Fi environment detecting unit 370, and the DR processing unit 380.

The GPS unit 320 may be configured to receive GPS information from a satellite using the GPS module. The Wi-Fi unit 330 may be configured to transmit and receive a signal with a neighboring Wi-Fi AP via a Wi-Fi module. The sensor 340 may be configured to detect the state information for the operation devices of the vehicle 300. As an example, the sensor 340 may be at least one of an acceleration sensor, a gyro sensor, a vehicle speed sensor, and a steering angle sensor (SAS). Additionally, the sensor 340 may be configured to detect an obstacle extraneous to the vehicle 300 or a distance to the obstacle, or the like.

The signal processing unit 310 may be configured to transmit and receive signals via the Wi-Fi unit 330. In particular, the reception of the signal via the GPS module may be blocked when the vehicle 300 enters the indoor parking lot. Therefore, the Wi-Fi environment detecting unit 370 may be configured to enable the driving of Wi-Fi module to recognize the Wi-Fi AP in the parking lot when the vehicle enters the parking lot. In particular, the Wi-Fi environment detecting unit 370 may be configured to recognize at least one of SSID, MAC address, signal strength, and noise signal strength of the Wi-Fi AP.

The DR processing unit 380 may be configured to obtain the information of the vehicle 300 by operating the sensor 340 mounted within the vehicle 300 when the Wi-Fi AP is recognized by the Wi-Fi environment detecting unit 370, and recognize a relative position between the corresponding vehicle 300 and the Wi-Fi AP in the parking lot using the obtained information. As an example, the DR processing unit 380 may be configured to perform a dead reckoning using the measured information by at least one of the acceleration sensor, the gyro sensor, the vehicle speed sensor, and the steering angle sensor (SAS). In particular, the signal processing unit 310 may be configured to enable the communication unit 350 to provide the information of the Wi-Fi AP recognized by the Wi-Fi environment detecting unit 370 and the relative position information between the corresponding vehicle 300 and the Wi-Fi AP in the parking lot recognized by the DR processing unit 380 to the storage server and service server.

Meanwhile, the Wi-Fi environment detecting unit 370 may be configured to compare the Wi-Fi AP list with the information of the Wi-Fi AP recognized in the parking lot when the information of the Wi-Fi AP of the corresponding parking lot is received from the storage server. In particular, the Wi-Fi environment detecting unit 370 may be configured to sense the Wi-Fi environment change for the parking lot based on the result of the comparison, and provide the sensed Wi-Fi environment information to the storage server.

As an example, the Wi-Fi environment detecting unit 370 may be configured to determine that the Wi-Fi environment of the parking lot has changed when the signal from the Wi-Fi AP included in the Wi-Fi AP list is not sensed or the signal from the Wi-Fi AP that is not included in the Wi-Fi AP list is sensed. The Wi-Fi environment detecting unit 370 may be configured to detect the search position as a predetermined area based on the signal strength of the recognized Wi-Fi AP in the parking lot and store the Wi-Fi environment information by the Wi-Fi AP recognized at the detected search position into the storage unit 360. The Wi-Fi environment detecting unit 370 may also be configured to provide the Wi-Fi environment information stored in the storage unit 360 to the storage server.

Furthermore, the Wi-Fi environment detecting unit 370 may be configured to store the Wi-Fi environment information by the Wi-Fi AP recognized in the parking lot into the storage unit 360 in response to determining that the Wi-Fi environment of the parking lot is not changed. Similarly, the Wi-Fi environment detecting unit 370 may also be configured to provide the Wi-Fi environment information stored in the storage unit 360 to the storage server.

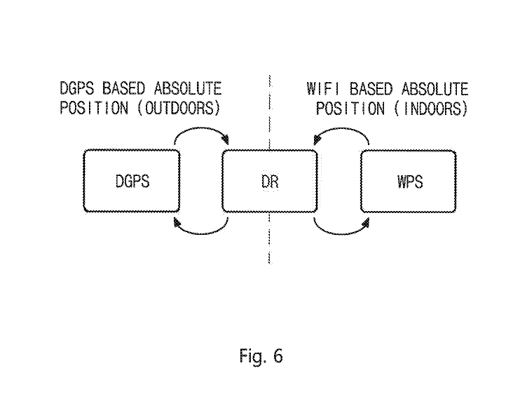

FIG. 6 is an exemplary diagram for describing a communication conversion operation of the vehicle shown in FIG. 5. As shown in FIG. 6, the vehicle may be configured to recognize absolute position based on differential global positioning system (DGPS) and DR by operating a GPS module and a sensor in the outdoor environment. Further, the vehicle may be configured to recognize the absolute position based on Wi-Fi Protected Set-Up (WPS) and DR by operating a Wi-Fi module and the sensor in the indoor environment in which the GPS signal is relatively weak.

Therefore, the vehicle (e.g., the processor in the vehicle) of the present invention may be configured to determine the substantially exact positioning both indoors and outdoors. As a result, the vehicle may be configured to recognize the Wi-Fi AP positioned in the indoor parking lot and may provide the measured position information to the recognized Wi-Fi AP in real time.

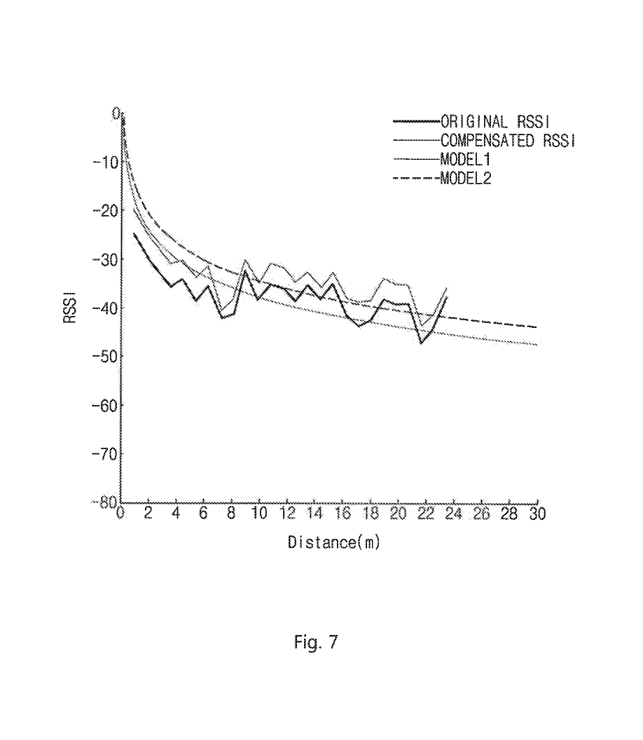

FIG. 7 is an exemplary graph describing a position calculating operation between Wi-Fi AP and vehicle in a storage server according to the exemplary embodiment of the present invention.

When the vehicle enters the parking lot, the storage server may be configured to receive AP signal from the Wi-Fi AP and receive the vehicle signal from the vehicle that has entered the parking lot. The storage server may be configured to determine the attenuation level of the signal by comparing the received signal strength of the AP signal and vehicle signal, to calculate a distance between the Wi-Fi AP and vehicle.

FIG. 7 is an exemplary graph illustrating the strength of the received signal based on the transfer distance. Here, a distance that corresponds to a path loss of the received signal may be calculated using the following Equation 1.

$$L = 20 {log}_{10} ( \frac{4 πd}{λ} ) [ dBm ] \\ d = \frac{λ}{4 π} \times {10}^{\frac{L}{20}} = \frac{c}{4 π f} \times {10}^{\frac{L}{20}} [ m ] \qquad [ Equation 1 ]$$

In the above Equation 1, L represents a path loss, λ represents a wavelength of radio wave, d represents a distance, c represents a speed of the radio wave (=3×108), and f represents a frequency (=2.4[GHz]).

Therefore, the storage server may be configured to calculate the distance between the Wi-Fi AP and vehicle and may be configured to estimate the position of the vehicle based on the position in which the corresponding Wi-Fi AP is installed.

The flow of operation of the system for managing information of parking lot according to the exemplary embodiment of the present invention will be described in detail.

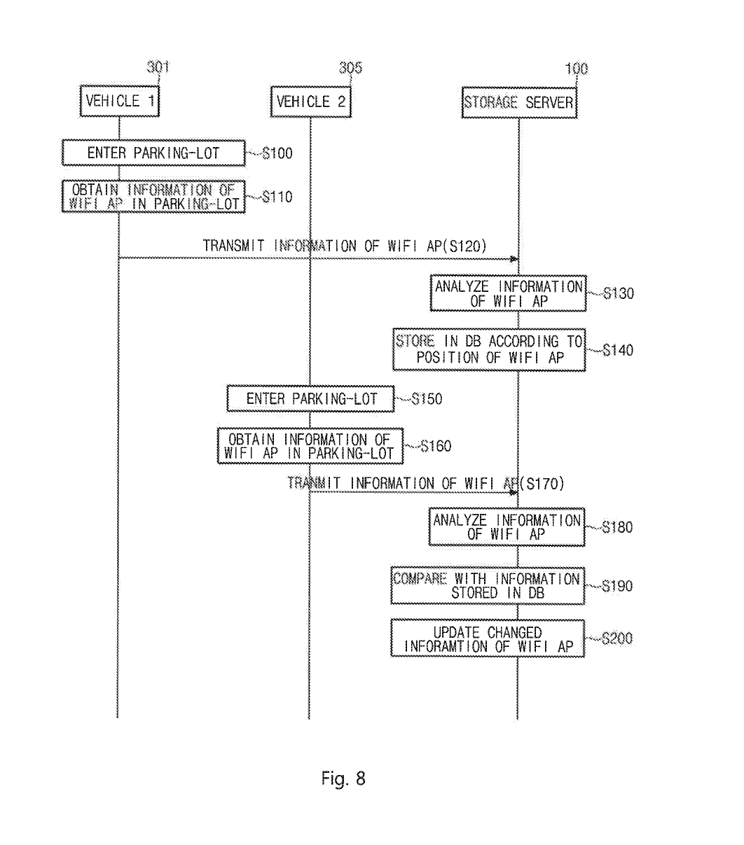

FIG. 8 is an exemplary flow chart illustrating a flow of operation for a method for managing information of parking lot according to the exemplary embodiment of the present invention. Referring to FIG. 8, when a vehicle 1 301 (e.g., it may be a vehicle that builds Wi-Fi AP DB for collecting information) enters the parking lot (S100), the vehicle may be configured to obtain the information of Wi-Fi AP in the parking lot (S110), and transmit the obtained information to the storage server 100 (S120).

In particular, the storage server 100 may be configured to analyze the information of the Wi-Fi AP received from the vehicle 1 301 (S130) and store the corresponding Wi-Fi AP information based on the position of the Wi-Fi AP into the DB (S140). The storage server 100 may be configured to divide each of Wi-Fi AP information by parking lot to store to the DB.

Thereafter, when a vehicle 2 305 (e.g., it may be a vehicle of general customers using the parking lot) enters the parking lot (S150), the vehicle (e.g., the vehicle processor) may be configured to obtain the information of the Wi-Fi AP in the parking lot (S160), and transmit the obtained information to the storage server 100 (S170). The storage server 100 may be configured to analyze the information of the Wi-Fi AP received from the vehicle 2 305 (S180), compare with the information of the Wi-Fi AP stored in the DB (S190), and update the information of the Wi-Fi AP changed based on result of the comparison (S200). Here, the steps 150 to 200 may be repeatedly performed when the vehicle enters the parking lot, to continuously update the information of the Wi-Fi AP stored in the DB.

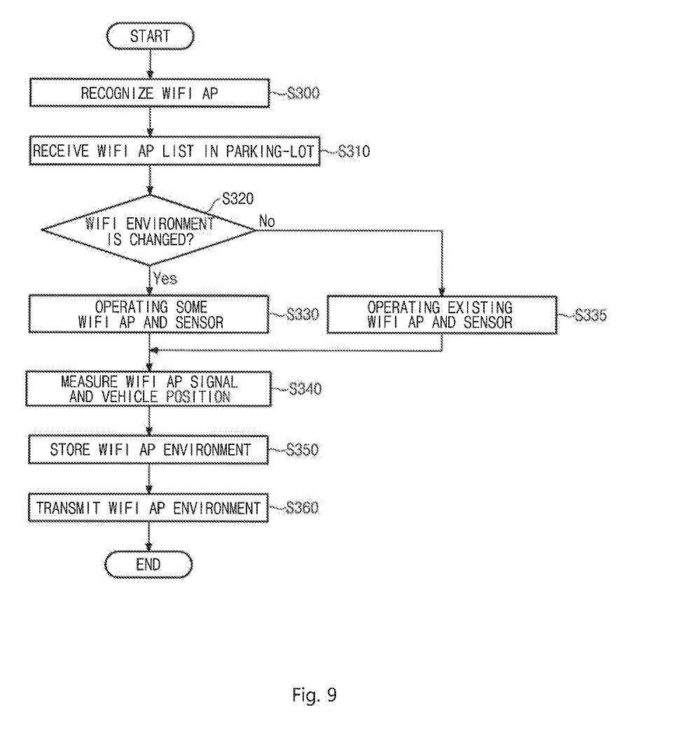

FIG. 9 is an exemplary flow chart illustrating a flow of operation for a method for managing information of parking lot according to the exemplary embodiment of the present invention. Referring to FIG. 9, the parking lot information providing apparatus, that is, a vehicle 300 may be configured to recognize the Wi-Fi AP at the time of entering in the parking lot (S300). In addition, the vehicle 300 may be configured to receive the Wi-Fi AP list in the parking lot from the storage server 100 (S310).

The vehicle 300 may be configured to compare the received Wi-Fi AP list with the Wi-Fi AP information recognized at step 300 and determine whether the Wi-Fi environment is changed. When the Wi-Fi environment is changed (S320), the vehicle 300 may be configured to detect the search position based on the signal strength of the Wi-Fi AP in the parking lot, and measure the position of the Wi-Fi AP via some Wi-Fi APs and sensors disposed at a detected search position (S330, S340). At step 340, the vehicle 300 may be configured to measure a relative position between the vehicle 300 and the Wi-Fi AP.

On the other hand, when the Wi-Fi environment is not changed (S320), the vehicle 300 may be configured to measure the position of the Wi-Fi AP via the Wi-Fi AP and sensor disposed in the parking lot (S330, S340). At step 340, the vehicle 300 may be configured to measure a relative position between the vehicle 300 and the Wi-Fi AP. Thereafter, the vehicle 300 may be configured to store the recognized Wi-Fi AP environment (S350) and transmit the corresponding Wi-Fi AP environment to the storage server 100 (S360).

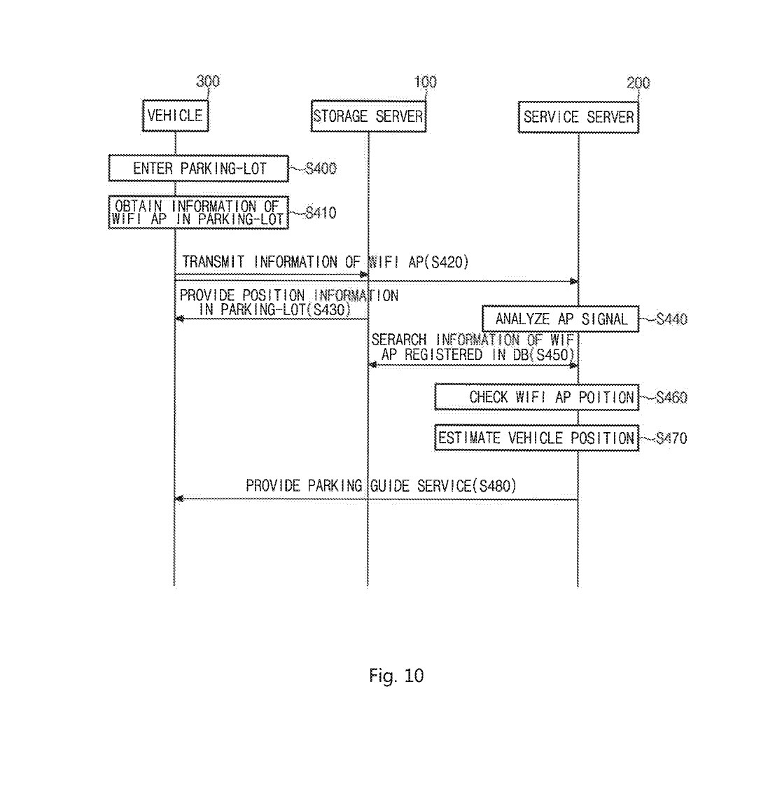

FIG. 10 is an exemplary flow chart illustrating a flow of operation for a method for managing information of parking lot according to another exemplary embodiment of the present invention. Referring to FIG. 10, when the vehicle 300 enters the parking lot (S400), the vehicle may be configured to obtain the information of the Wi-Fi AP in the parking lot to transmit to the storage server 100 and the service server 200 (S420). In addition, the storage server 100 may be configured to provide the position information of the vehicle 300 in the parking lot (S430).

Meanwhile, the service server 200 may be configured to analyze the AP signal (S440) and search the Wi-Fi AP information registered in the DB of the storage server 100 (S450) to obtain the information of the Wi-Fi AP that corresponds to the AP signal. Thus, the service server 200 may be configured to identify the position of the Wi-Fi AP (S460). The service server 200 may be configured to estimate the position of the vehicle 300 based on the information of the Wi-Fi AP received from the vehicle 300 and the position of the Wi-Fi AP (S470), and provide a parking guide service to the corresponding vehicle 300 based on the estimated position (S480).

As set forth above, the system and method of the exemplary embodiment of the present invention may store the indoor parking lot information in the DB using the Wi-Fi and DR information provided in the existing vehicle, thereby easily acquiring information, and conveniently managing the parking lot information. In addition, the system and method of the exemplary embodiment of the present invention may continuously update the pre-registered information based on the Wi-Fi information provided from the vehicles entering the parking lot, thereby making it possible to increase reliability of the information registered in the DB.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the accompanying claims.

What is claimed is:

1. A system for managing information of a parking lot, the system comprising:
a processor operating in a vehicle is configured to recognize information regarding a wireless access point (Wi-Fi AP) in the parking lot and provide the information of the Wi-Fi AP of the parking lot; and
a storage server is configured to receive the information of the Wi-Fi AP for each parking lot from the processor to store the information into a database (DB), and manage the information of the Wi-Fi AP for each parking lot stored in the DB,
wherein the storage server is configured to provide position information based on the information of the Wi-Fi AP of the parking lot to a corresponding vehicle when the vehicle enters the parking lot, and is configured to update the information of the Wi-Fi AP previously stored for a corresponding parking lot based on the information of the Wi-Fi AP received from the vehicle that entered the parking lot.

2. The system of claim 1, wherein the storage server is configured to generate a Wi-Fi AP list for at least one Wi-Fi AP positioned at the parking lot and store at least one of identification information, access information, signal strength information, position information, and reliability information that correspond to each Wi-Fi AP in the Wi-Fi AP list.

3. The system of claim 2, wherein the storage server is configured to estimate a position of the Wi-Fi AP by analyzing a signal of the Wi-Fi AP based on a location coordinate in the parking lot.

4. The system of claim 2, wherein the storage server is configured to store at least one Wi-Fi AP information obtained at a predetermined position in the parking lot into the DB 130 in response to the predetermined position information.

5. The system of claim 2, wherein the storage server is configured to analyze an intensity of the AP signal periodically received from the vehicles to calculate reliability of each Wi-Fi AP.

6. The system of claim 1, wherein the storage server is configured to update at least one of a removed AP, an added AP, and an AP having a signal strength which is a reference value or less among the pre-registered Wi-Fi APs for the parking lot.

7. The system of claim 1, further comprising:
a service server is configured to analyze an AP signal received from the vehicle that entered the parking lot to estimate a position of the vehicle and provide a parking guide service to a corresponding vehicle based on the estimated position.

8. The system of claim 7, wherein the service server is further configured to:
search an Wi-Fi AP that corresponds to the AP signal received from the vehicle that entered in the parking lot by calling the DB when the vehicle enters the parking lot; and
estimate the position of the corresponding vehicle based on position information of the searched Wi-Fi AP.

9. A method for managing information of a parking lot, the method comprising:
recognizing, by a processor, information regarding a wireless access point (Wi-Fi AP) of a corresponding parking lot by at least one vehicle that entered the parking lot;
receiving, by the processor, the information regarding the Wi-Fi AP recognized from the at least one vehicle;
analyzing, by the processor, the information regarding the Wi-Fi AP for each parking lot;
storing, by the processor, the information regarding the Wi-Fi AP into a database (DB) based on a position of each Wi-Fi AP;
receiving, by the processor, Wi-Fi environment information regarding the corresponding parking lot based on the information regarding the Wi-Fi AP of the parking lot when the vehicle enters the parking lot; and
updating, by the processor, the DB by analyzing the Wi-Fi environment information of the corresponding parking lot.

10. An apparatus for providing parking lot information, the apparatus comprising:
a processor configured to:
recognize a wireless access point (Wi-Fi AP) in a parking lot by operating a Wi-Fi module when a vehicle enters the parking lot;
obtain information regarding the vehicle by operating a sensor installed within the vehicle and recognizing a relative position of a corresponding vehicle in the parking lot using the obtained information; and
provide the information of the Wi-Fi AP in the parking lot and relative position information of the vehicle to a storage server,
wherein the processor is configured to compare a Wi-Fi AP list received from the storage server with the information of the Wi-Fi AP in the parking lot to sense a Wi-Fi environment change for the parking lot when the information of the Wi-Fi AP of the corresponding parking lot is previously stored in the storage server, and provide the sensed Wi-Fi environment information to the storage server.

11. The apparatus of claim 10, wherein the processor is configured to operate the sensor to sense at least one of service set identifier (SSID), media access control (MAC) address, signal strength, and noise signal strength of the Wi-Fi AP.

12. The apparatus of claim 11, wherein the processor is further configured to:
detect a search position based on the signal strength of the Wi-Fi AP in the parking lot when it is determined that a Wi-Fi environment for the parking lot is changed; and
provide the Wi-Fi environment information by the Wi-Fi AP recognized at the detected search position into a memory.

13. The apparatus of claim 11, wherein the processor is configured to provide the Wi-Fi environment information using the Wi-Fi AP in the parking lot to the storage server when it is determined that a Wi-Fi environment for the parking lot is not changed.

14. The apparatus of claim 10, wherein the processor is further configured to:
perform a dead reckoning using information measured by at least one of an acceleration sensor, a gyro sensor, a vehicle speed sensor, and a steering angle sensor (SAS).

15. A non-transitory computer readable medium containing program instructions executed by a processor, the computer readable medium comprising:
program instructions that recognize a wireless access point (Wi-Fi AP) in a parking lot by operating a Wi-Fi module when a vehicle enters the parking lot;
program instructions that obtain information regarding the vehicle by operating a sensor installed within the vehicle and recognizing a relative position of a corresponding vehicle in the parking lot using the obtained information; and
program instructions that provide the information of the Wi-Fi AP in the parking lot and relative position information of the vehicle to a storage server,
wherein the program instructions compare a Wi-Fi AP list received from the storage server with the information of the Wi-Fi AP in the parking lot to sense a Wi-Fi environment change for the parking lot when the information of the Wi-Fi AP of the corresponding parking lot is previously stored in the storage server, and provide the sensed Wi-Fi environment information to the storage server.

16. The non-transitory computer readable medium of claim 15, further comprising:
program instructions that operate the sensor to sense at least one of service set identifier (SSID), media access control (MAC) address, signal strength, and noise signal strength of the Wi-Fi AP.

17. The non-transitory computer readable medium of claim 16, further comprising:
program instructions that detect a search position based on the signal strength of the Wi-Fi AP in the parking lot when it is determined that a Wi-Fi environment for the parking lot is changed; and
program instructions that provide the Wi-Fi environment information by the Wi-Fi AP recognized at the detected search position into a memory.

18. The non-transitory computer readable medium of claim 16, further comprising:
program instructions that provide the Wi-Fi environment information using the Wi-Fi AP in the parking lot to the storage server when it is determined that a Wi-Fi environment for the parking lot is not changed.

19. The non-transitory computer readable medium of claim 15, further comprising:
program instructions that perform a dead reckoning using information measured by at least one of an acceleration sensor, a gyro sensor, a vehicle speed sensor, and a steering angle sensor (SAS).
